(19) United States
(12) Patent Application Publication
(10) Pub. No.: US 2015/0155127 A1
(43) Pub. Date: Jun. 4, 2015

(54) CARBON NANOTUBE-BASED ION SOURCE FOR PARTICLE GENERATOR

(71) Applicants: Richard Lee Fink, Austin, TX (US); Nan Jiang, Austin, TX (US)

(72) Inventors: Richard Lee Fink, Austin, TX (US); Nan Jiang, Austin, TX (US)

(73) Assignee: Applied Nanotech Holdings, Inc., Austin, TX (US)

(21) Appl. No.: 12/400,337

(22) Filed: Mar. 9, 2009

Related U.S. Application Data
(63) Continuation-in-part of application No. 12/276,109, filed on Nov. 21, 2008, now abandoned.
(60) Provisional application No. 60/990,366, filed on Nov. 27, 2007.

(51) Int. Cl. H01J 27/20

(52) U.S. Cl. CPC H01J 27/205

(57) ABSTRACT

A neutron generator includes carbon nanotubes that function as the anode and provide deuterium storage. The ionization source includes a layer of carbon nanotubes that provides a pulse of deuterium ions through field-induced desorption and ionization of deuterium atoms on the surface or retained in the bore of the nanotubes. A high-yield (>10¹⁰ n/s) neutron generation is achieved by employing a field desorption ion source and applying an electric field of 10-40 V/nm. Such high fields may be achieved with carbon nanotubes having high aspect ratios with field enhancement factors on the order of 1000. By operating the ion source in a background pressure of deuterium or hydrogen, the gas adsorption on the nanotubes may be regenerated after each pulse.

### CROSS-REFERENCE TO RELATED APPLICATIONS

This application is a continuation-in-part of U.S. patent application Ser. No. 12/276,109 filed Nov. 21, 2008, which claims priority to U.S. Provisional Application Ser. No. 60/990,366, filed Nov. 27, 2007, both of which are hereby incorporated by reference herein.

### General

The Domestic Nuclear Detection Office (DNDO) within the Department of Homeland Security (DHS) is tasked with the deployment of a national nuclear detection system. In July 2007, the U.S. Congress passed legislation mandating that by 2012 all foreign cargo containers shipped to the U.S. must be scanned for nuclear devices and materials before leaving foreign ports, using non-intrusive imaging technology and radiation detection equipment. This underscores a need for enabling technologies that will allow inspection of objects to identify special nuclear material (SNM).

“Special nuclear material” (SNM) is defined by Title I of the Atomic Energy Act of 1954 as plutonium, uranium-233, or uranium enriched in the isotopes uranium-233 or uranium-235. These materials are only mildly radioactive, but include some fissile material—uranium-233, uranium-235, and plutonium-239—that, in concentrated form, can be the primary ingredients of nuclear explosives. Passive radiation techniques will not work since the naturally occurring radiation is either very small or too weak to penetrate container walls or can be otherwise be shielded. Given the high volume of shipping containers arriving at U.S. ports and border check points, smuggling prevention of these materials necessitates instrumentation that is compact, efficient and low-power for mobile non-intrusive inspection. The inspection must be rapid and have a low error rate so as not to interrupt the flow of legitimate commerce.

There are four known viable approaches to detection of SNM that are distinguished by the interrogation source (neutrons or gamma rays) and the induced radiation signature (neutrons or gamma rays). Most research has focused on neutron emission resulting from neutron activation. The neutron signal that is emitted after neutron activation is delayed from a fraction of a second to a few minutes, depending on the SNM material being probed. The neutron signature may also be weak and subject to absorption by material surrounding the source. For these and other reasons discussed below, neutron sources for the detection of SNM may have a narrow pulse width, low source neutron energy, and high yield, and may be based on non-radioactive materials.

### BRIEF DESCRIPTION OF DRAWINGS

FIG. 1 illustrates a neutron generator;

FIG. 2 illustrates a field emission apparatus;

FIG. 3 illustrates ionization of hydrogen from a substrate coated with CNTs;

FIG. 4 illustrates a triode configuration of the apparatus illustrated in FIG. 3;

FIG. 5 illustrates a neutron generator;

FIG. 6 illustrates a neutron generator;

FIG. 7 illustrates a neutron generator;

FIG. 8 illustrates a prior art neutron generator;

FIG. 9 illustrates a prior art neutron generator;

FIG. 10 illustrates a prior art neutron generator;

FIG. 11 illustrates a neutron generator;

FIG. 12 illustrates a neutron generator; and

FIG. 13 illustrates a neutron generator.

### DETAILED DESCRIPTION

Field ionization technology described herein may be used to produce a deuterium ion (D⁺ or D₂⁺) current for a neutron source or γ-ray source enabling fast switching, high repetition rate and high yields. Carbon nanotubes (CNT), with hydrogen storage capacity and a high aspect ratio structure that induces electric field concentration for electron field emission and field ionization applications, are advantageously suited to this application. A near-monochromatic γ-ray source is also described.

A common neutron-based technique employed to detect fissile material is differential die-away (DDA). In this method, the item to be inspected is placed in a chamber or enclosure containing a pulsed source of energetic, or fast, neutrons. The fast neutrons slow down to thermal energies and then die away over a period of microseconds to milliseconds, depending on the thermal neutron capture properties of the environment. If SNM material is present in the item, then fission events induced by thermal neutrons may perturb the die-away characteristics of the thermal neutron fluence rate due to the addition of fission neutrons. Consequently, by monitoring the thermal neutron fluence rate die-away time with a thermal neutron detector between fast neutron pulses, the presence of SNM material in an item may be detected.

Another method, referred to as Prompt Neutron Neutron Activation Analysis (PNNAA) (See U.S. Patent Application Publication No. 2005/0220247), may be used to detect concealed fissile materials such as SNM in a container with high precision and is not defeated easily by radiation shielding. PNNAA relies on the detection of prompt fast fission neutrons emitted by SNM during the time interval between pulses of fast source neutrons (energy greater than 100 keV). Because the fast source neutrons die away within less than a microsecond after the end of a pulse, the fast neutron background between pulses is insignificant if the period is of the order of microseconds and the detector counting is set to start after the end of a pulse and set to stop before the start of the next pulse. If SNM material is present in the container, then fast fission neutrons may be emitted between pulses through fission events induced by both fast and thermal neutrons. Their detection may provide an indication of the presence of fissile material. Unlike DDA, the PNNAA relies on the direct measurement of fast (i.e., energetic) neutrons produced by fission.

SNM material-detection techniques that rely solely on thermal-neutron reactions in the material may be circumvented by reducing the thermal neutron flux with a thermal neutron absorber. These absorbers are much less effective at preventing fast or even epithermal neutron-induced reactions in the material. Consequently, PNNAA may potentially overcome such masking attempts through detection of neutrons emitted by energetic (not-thermal) neutron-induced fission. Preferably, the neutron source has pulse widths of 10 nanoseconds or less, the source neutron energy is low (less than 8.5 MeV) to avoid interference reactions, and the source strength (or yield) is on the order of 10⁷ to 10¹² neutrons/second. PNNAA is just one exemplary technique that illustrates the need for improved compact neutron generators.

There are neutron-based inspection techniques that look for other contraband materials that also use similar fast-pulse sources, especially for imaging techniques (See Tashi Gozani, “A Review of Neutron Based Non-Intrusive Inspection Techniques,” Conference on Technology for Preventing Terrorism, Hoover Institution, Mar. 12-13, 2002; see also T. Gozani and P. Shea, “Explosives Detection System,” U.S. Pat. No. 5,006,299). Neutron activation coupled with g-ray detection has also been shown (Dennis Slaughter et al., “Detection of Special Nuclear Material in Carbon Containers Using Neutron Interrogation,” Lawrence Livermore Nat. Lab. report UCRL-ID-155315 (2003)) to be a very promising tool for detecting SNM. An activated neutron energy less than 8.7 MeV may help avoid signature interference from activated oxygen and argon.

Neutron generators may be based on radioactive materials such as californium 252 (Cf-252), or accelerator-based D-D reactions or D-T reactions. Radioactive materials have low intensity, cannot be switched off and are difficult and expensive to own. One goal of many governments is to reduce or eliminate the use of these materials. D-T generators deliver 14 MeV neutrons that may produce interfering background signals unless the source neutrons are thermalized. They also suffer from limited lifetimes and are complicated by transportation and operational safety concerns. The D-D reaction source is the best choice but traditionally suffers from low neutron yields. The D-D reaction of interest is:

D+D→n+³Hₑ Eₙ=2.5 MeV for low energy D⁺ acceleration of order 100 keV Equation 1

The compact D-D reaction neutron generator includes a source of D⁺ or D₂⁺ ions that are then accelerated to an energy of about 80-180 keV towards a target that also contains D. The neutron yield is determined by the ion current, the density of the D atoms at the target near the surface, the energy of the ion beam, and the ratio of D⁺ to D₂⁺. For reasons of efficiency and to limit the size of the accelerator power supply, D⁺ ions are preferred. Most of the compact, portable neutron sources currently available commercially use either a Penning ion source or an RF-driven plasma source. The rise and fall time of a Penning ion source is on the order of 1.5 psec and is unpredictable. Neutron generators made with a Penning ion source have relatively low yields (10⁶-10⁷ n/s). RF-plasma driven sources may allow higher ion current densities, but are difficult to switch at fast speeds and, because of the RF matching circuits required, they are bulky and not sufficiently efficient for portable applications.

A field desorption ion source was demonstrated by P. Schwoebel (P. R. Schwoebel, “Field Desorption Ion Source for Neutron Generators,” Appl. Phys. Lett., 87, p. 54104, 2005) using metal microtip arrays of both tungsten tips and molybdenum tips, commonly referred to as Field Emitter Arrays (FEAs). Schwoebel demonstrated that these FEAs would store a charge of hydrogen on their surface and that when an electric field was applied, hydrogen would desorb from the surface and form H⁺ ions (he also demonstrated forming D⁺ ions). Schwoebel found that the desorption and ionization pulse created an ion current pulse that was approximately 10-20 nsec wide. When the ionization current was switched on, desorption took place almost immediately. The recharge rate was much slower and highly dependent on the background pressure. Thus with a FEA ionization source, one could (1) create fast (20 nsec) ion pulse currents without having to have fast turn-off power supplies, (2) achieve high pulse ion currents and thus large neutron yields (estimated to be 10⁸ n/pulse/cm² of FEA area) by having large densities of field ionization structures and (3) demonstrate pulsed ion current using a low switching voltage by way of a gated structure.

Carbon nanotubes may be used as electron sources for e-beam applications, including field emission displays (FEDs), cold-cathode x-ray tubes and microwave devices such as traveling wave tubes (TWTs).

An electric field approximately several megavolts/cm (˜several 100 V/μm) may be used to produce electron emission from materials. One way to achieve these fields is to use conducting or semiconducting structures or materials that have very high aspect ratios (i.e., tall and thin) and place them in an electric field. Because the high aspect ratios may concentrate the electric fields at the ends or tips of the structures, electron field emission may be achieved with applied electric fields as low as 1-10 V/μm, since the electric field at the tips of these high aspect features can be as high as 100-1000 V/μm. FIG. 2 illustrates this concept.

By switching the electric field direction, the same carbon nanotubes used for electron field emitters may be used as a source of ions by operating in a field ionization mode. For either mode, the phenomenon that controls the behavior is quantum mechanical tunneling of electrons from the conduction band of the metal into the vacuum or gas environment as a result of high local electric fields, or the reverse, electron tunneling from the gas molecules into the metal from similar applied electric fields, but polarized in the opposite direction. Besides the work of Schwoebel, there are other examples of using carbon emitters as gas ionization sources in the literature. Dong et al. and Choi et al. used CNT emitters in ionization vacuum gauges, but in a field emitter mode (C. Dong et al., APL., 84, p. 5443, 2004; and In-Mook Choi et al., APL., 87, p. 173104, 2005). Riley et al. (D. J. Riley et al., “Helium Detection via Field Ionization from Carbon Nanotubes,” NanoLetters, 3, p. 1455 (2003)) used multiwall carbon nanotubes to successfully ionize helium atoms using the field ionization mode described here.

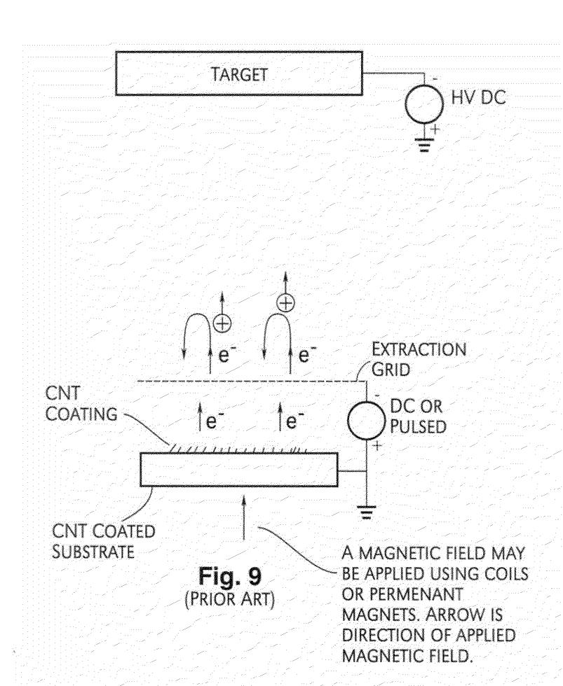

Chu and Liu (International Publication WO 2008/030212 “Miniature Neutron Generator for Active Nuclear Materials Detection”), disclose an ion source for neutron generator applications that uses ions generated by field-ionization from carbon nanotubes, nanorods or metal multi-tips. Chu and Liu describe a beam of deuterium ions formed from this ion source that is accelerated to a target at high voltage. They describe a simple system of ion source and target only and DC power supplying the potential to the target and supplying the field needed to create ions at the anode. FIG. 8 is a schematic of the system described by Chu and Liu.

Disclosed herein is a field ionization approach to creating the deuterium or tritium ion current, which results in fast switching, high repetition rate, and high yields. An advantage of the field ionization approach is that in one embodiment only a single high voltage power source is needed for both ion production and acceleration. To make a pulsed neutron source, the high voltage supply may be switched on and off quickly, or a substantial percentage of the high voltage (about 50% or more) may be modulated. This approach allows for greater ion current and significant ease of manufacturing since the design of the neutron source may be very simple.

In another embodiment, the ion source may be switched on and off independently of the voltage applied to the target. This embodiment allows the target to remain at high voltage to achieve the high neutron yields from the ion source while allowing the ion beam to be modulated using a control or ion extraction grid placed between the anode surface and the target electrode.

One embodiment of this disclosure describes an ion source including a hollow anode tube centered on a rod. The inner surface of the anode tube may be coated with a carbon nanotube film. The surface of the rod may be coated with Ti or other material that allows accumulation of deuterium (or tritium if desired in some applications) in order to facilitate the energetic reaction described in Equation 1. Target materials may include metal hydrides. In this embodiment the center rod is the target (cathode) and is installed coaxially with the anode tube. When a high voltage (˜80 kV) pulse is applied between the anode and the cathode, a strong electric field may concentrate around the ends of the carbon nanotubes on the inner surface of the anode tube. If the electric field is strong enough, electrons from the deuterium atom may tunnel into the carbon nanotubes. Deuterium ions may be created and accelerated to the target electrode. As a result of the acceleration of the deuterium ions to the deuterium-loaded target, a D-D fusion reaction may occur on the surface of the target, and neutrons with energy of 2.4 MeV may be generated.

The deuterium charge at the source may be regenerated by the deuterium background pressure. Field ionization may occur if the gas atom or molecule is on the surface of the field emitter tip (e.g., a carbon nanotube fiber). This may be referred to as field desorption ionization. Field ionization may occur if the gas atom or molecule is near the field emitter tip where the field strength is high. This may be referred to as gas phase ionization. The volume of space where the ionization may occur may be quite small, e.g., on the order of angstroms or nanometers in diameter. The ion current from both processes may depend on the background gas pressure, field strength, duty factor, and other operating parameters.

The number of neutrons formed may depend on the ion beam current. If the total D⁺ beam current is 1 mA and the beam energy is 80 kV (total beam power is 80 W), then the output flux of D-D neutrons is approximately 10⁸ n/s. The neutron output flux from D-D reactions can be enhanced by increasing the applied high voltage.

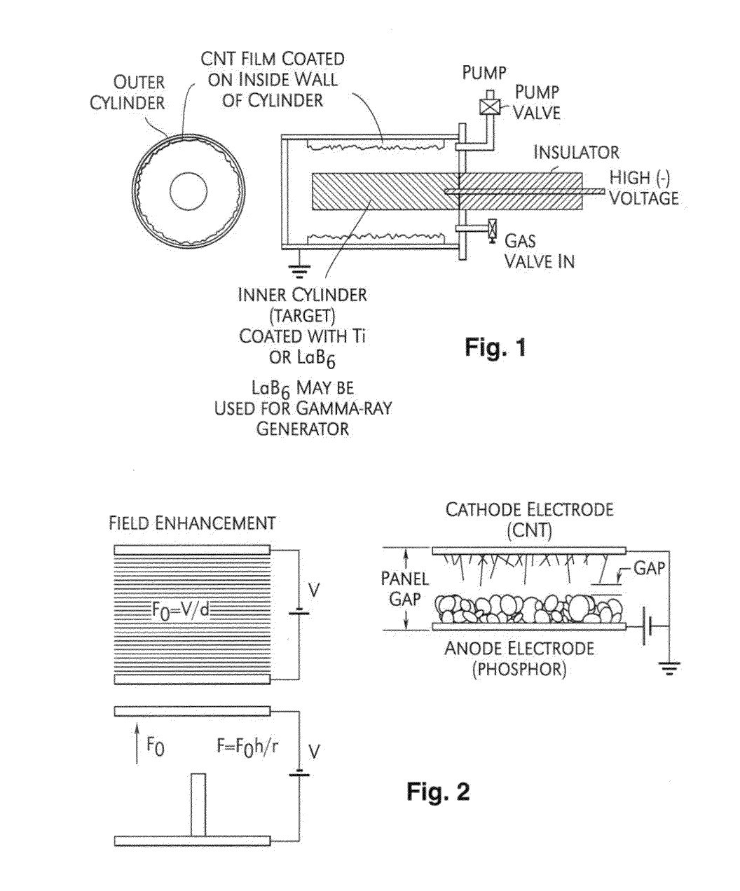

If high energy photons are used in the detection scheme, one can replace deuterium with hydrogen in the tube and replace the Ti with LaB₆ on the center rod shown as FIG. 1, and use the p+¹¹B nuclear reaction to produce the 11.4 MeV γ-rays. A higher operating voltage on the target may be needed to achieve high γ-ray yield.

In some configurations, an ionization source may include a layer of carbon nanotubes (CNTs) that provides a pulse of ions through field-induced desorption and ionization of atoms on the surface or retained in the bore of the nanotubes or through ionization of the gas atoms or molecules that come near the strong field of the field ionizer tip. A high-yield neutron generator employing a field desorption ion source is possible by applying an electric field of 10-40 V/nm. The local field strength near the carbon nanotube field emitter tip may be much higher as a result of the high aspect ratios of carbon nanotubes with field enhancement factors of the order of 1000. By operating the ion source in a background pressure of D₂ or H₂, the ionizer may be operated continuously as a result of continuous gas adsorption on the nanotubes and/or as a result of gas atoms or molecules coming within the strong field of the ionizer tip.

An element of this disclosure is an anode with improved ion current using field-induced desorption and ionization. Carbon nanotubes may offer advantages including effective hydrogen storage as well as to generation of hydrogen or deuterium ions.

The lifetime of this type of neutron tube may be very long. If the source pressure is 10 mTorr, the total number of deuterium molecules in the tube may be about 3×10¹⁴. If the D-D neutron production rate is 10⁸ n/s, then the time for consuming all the deuterium fuel is about 10⁴ hours. The lifetime may be further extended by evacuating the generator and then recharging with D₂ gas. X-ray generation may be suppressed by a pair of permanent magnets installed on the external surface of the neutron tube, creating an axial magnetic field. If the magnetic field is sufficiently strong, then the secondary emission electrons created at the cathode target may be confined to the cathode surface, quenching possible X-ray production on the anode surface and also reducing the power of the high voltage supply.

Disclosed herein are materials for use as ion sources for neutron generation experiments. These materials, including, for example, bare single-wall carbon nanotubes (SWNTs), Ti-coated SWNTs, and Pd—Ag coated SWNTs, may be used to improve (e.g., optimize) gas phase field ionization and adsorption and field-induced desorption of deuterium (desorption ionization).

Multi-wall carbon nanotubes and double-wall carbon nanotubes may also be used. All may be used as electron field emitters or field ionizers but some have better properties than others and may be application dependent. Single-wall carbon nanotubes may have the lowest threshold for electron field emission (expect the same for field ionization of D), and a high capability of hydrogen storage, up to 6 wt. % storage capacity. This corresponds to hydrogen coverage of approximately 65% (G. Zhang et al., “Hydrogenation, Hydrocarbonation and Etching of SWNT,” J. Am. Chem. Soc., 128, 6026 (2006)). However, this number may be smaller at room temperature and standard pressure, nearly 1 wt. % (˜10% coverage), and may be determined experimentally for the sub-Torr pressure range at room temperature. The coverage may be in the range of 1-10%, with larger numbers corresponding to smaller diameter nanotubes.

Titanium-coated carbon nanostructures have a great potential for hydrogen storage as well. Recently it was shown that a single titanium (Ti) atom coated on a single-wall nanotube binds up to 4 hydrogen molecules (T. Yildirim et al., “Titanium-decorated carbon nanotubes as a potential high-capacity hydrogen storage medium,” Phys. Rev. Lett., 94, 175501 (2005)). Thus, Ti-coated SWNTs may hold as much as 8 wt % hydrogen. Another recent study (N. Akman et al., “Hydrogen storage capacity of titanium met-cars,” J. Phys.: Condens. Matter, 18, 9509 (2006)) showed that Ti—C clusters such as titanium metallocarbohedryne can bind up to 16 H₂ molecules. In a neutron generator, a thin Ti coating may not interfere with the field ionization performance (diameter to height ratio increases only slightly) and may allow the deuterium adsorption to be at the surface of the Ti film and not in the bulk, and thus more susceptible to field-induced desorption.

D₂ (or H₂) adsorbs on Ti through the processes of dissociative binding to its surface and further forming titanium deuteride (or hydride) in the bulk. The sticking probability of D₂ (or H₂) to Ti at room temperature is on the order of 10⁻⁴. For a titanium surface, recovery of an adlayer of deuterium or hydrogen requires deuterium gas exposures of 5-10 L (A. Azoulay et al., Hydrogen interactions with polycrystalline and with deposited titanium surfaces, J. Alloys Comp. 248, 209 (1997)) (1 L=10⁻⁶ Torr·s). In other words, if a working pressure of a neutron generator is 10 mTorr, a time delay of at least 1 ms may be needed to replenish the amount of deuterium on the anode surface. This is consistent with a pulsed repetition rate of 1000 Hz.

One embodiment includes deposition of a 5-200 Å Ti layer on the surface of the nanotubes. One means of doing that is by magnetron sputtering, but other physical or chemical deposition processes may be used. Since a thin Ti layer will be very reactive in air, the sputtering chamber will be backfilled with hydrogen-forming gas after the deposition is complete. This may help prevent oxidation of the surface of Ti by saturating it with hydrogen. The Ti coating may also be done in situ as a final step of the generator fabrication process.

Pd nanoparticles are another alternative for hydrogen storage. Bulk Pd can dissociatively absorb hydrogen, forming palladium hydride. The ratio of H/Pd in hydride can be as much as 0.6 at 20 Torr of hydrogen partial pressure at room temperature. At lower pressures, the H/Pd ratio will significantly decrease due to the phase transition in Pd to values not exceeding 0.01. This ratio may be increased at low pressures by alloying Pd with silver (F. A. Lewis, “The Palladium Hydrogen System,” Academic Press, New York, 1967) since Ag atoms will induce Pd lattice relaxation. On the other hand, hydrogen readily occupies Pd subsurface sites even in bulk palladium. As a result, palladium nanocrystals, having very high surface-to-bulk ratio, absorb much higher amounts of hydrogen than bulk material. With no presence of oxygen, hydrogen saturates Pd nanoparticles even at very low partial pressures (10 ppm and lower), corresponding to approximately 10 mTorr of hydrogen.

An electroplating technique may be used for deposition of Pd—Ag on carbon nanotubes. The plating process is fast, lasting approximately 10 minutes. Using a single plating bath, Pd—Ag nanoparticles may be deposited on up to 40 SWNT cathodes.

A Pd—Ag bath solution capable of making nanoparticle coatings with 40% Ag alloy content uses the following chemicals: 0.6 mM of PdCl₂, 0.4 mM of AgNO₃, 0.1 M of NaNO₃, 0.1 M of HCl, and 2 M of NaCl in water. The SWNT samples may be connected to a negatively biased working electrode. In this chronoamperometric plating system with a 3-wire configuration, a platinum coiled wire works as a counter electrode, and a Ag/AgCl electrode as the reference.

Pd—Ag coated anodes with different nanoparticle loading and nanoparticle size may be manufactured with loading in the range of 10 to 50 wt %, and a nanoparticle size of 5-20 nm.

Electric breakdown of the high voltage in the neutron generator may be avoided. One way to avoid this is to maintain relatively low gas pressure. On the other hand, a higher gas pressure may result in higher ion current (assuming more hydrogen is adsorbed at higher gas pressures) and a faster anode recharge rate. Based on mean-free-path calculations, the deuterium pressure range in the generator may range from ˜1 mTorr to 100 mTorr.

The adsorption of hydrogen on a CNT film may be about 1 wt. % at high pressure charging. The CNT film may be about 20 μm thick with a density of about 1/100 of bulk graphite. A CNT film of 1 cm² may have a mass of about 0.02 mg. If 0.1 wt. % of hydrogen is absorbed when charged at 10 mTorr, about 0.02 μgrams of hydrogen may be absorbed on the CNT film. The Ti and Pd—Ag treated films may have higher hydrogen mass storage. If this film were to be placed in a lab scale vacuum chamber and all the absorbed gas was released as a result of field induced desorption, a pressure rise of ˜10⁻⁵ Torr may be measured. Even a measured pressure increase of 10⁻⁸ Torr may be sufficient to achieve the 10⁸ n/sec goal.

0.02 μgrams of hydrogen may be released from a 1 cm² CNT film. If only 1% of these atoms (about 6×10¹⁴) are converted to charged ions, the total coulombic charge is 100 μC/pulse. This is much higher than the value of 2 μC/cm² predicted by Schwoebel using metal microtip cathode. If this charge is recreated in one μsec, the peak current from 1 cm² is about 100 Amps. In the design of FIG. 1, the area of the CNT film is about 50 cm². Thus, the expected ion pulse from a CNT film may much higher than the ion pulse from a metal microtip source. Assuming a 1000 Hz cycle rate, a 10⁻⁶ C/pulse or 10⁻⁸ C/cm²/pulse may result in 1 mA time-averaged ion current, given the design of FIG. 1. The actual amount of ion current measured may impact the design of the ion source.

Ionization of H₂ from the CNT coated substrate may be tested by using a substrate that has been “loaded” with H₂, in a vacuum, or by using a substrate in a background partial pressure of H₂. The test in the vacuum may include equipment such as a turbo pumped vacuum system with a hydrogen supply to vacuum system, a high voltage power supply and high voltage switcher/pulser, and control and measurement electronics.

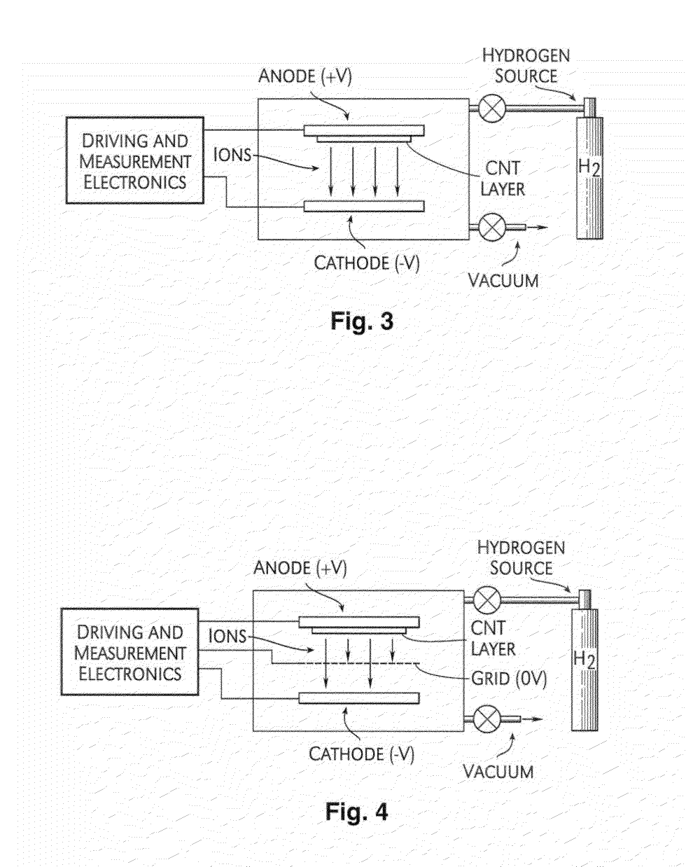

The CNT coated substrate may be assembled in a diode configuration with a cathode using a predetermined gap. This assembly may be mounted into the vacuum chamber and the system pumped to vacuum. After achieving a base pressure, H₂ may be let into the system to “load” the substrate with H₂. The system may be pumped to a base pressure to remove the residual atmosphere of H₂. A test setup is shown in FIG. 3.

A voltage may be applied to the device to create a high electric field between the anode and cathode. The voltage may be either a ramped DC voltage or pulsed. When the field becomes high enough, ion current is observed. The ion current is short lived, so precision measurement electronics are used.

After the H₂ is depleted, the substrate may be recharged by bleeding H₂ back into the vacuum system. After pumping out the residual H₂, the process may be repeated. By completing several tests, it may be determined at what electric field the ionization is taking place. The voltage may then be pulsed to the proper potential to obtain a sharp ionization current peak.

An effect of a pulsed, high voltage diode operation is a capacitance charging current spike. This spike may interfere with the ion current measurement. To prevent this, a shielding grid may be needed for pulsed voltage operation. This would make the device a triode instead of a diode (see FIG. 4). The grid may be introduced between the two substrates and in effect becomes the cathode, while the previous cathode substrate becomes a collector plate. The high electric field is then generated between the CNT coated anode pulsed to positive high voltage and the cathode-grid, which may be at ground potential. A smaller negative voltage may be maintained on the collector plate to collect the ions passing through the openings in the grid. There is some collection of ions on the grid, depending on the mesh transparency, however enough may pass through to obtain a current measurement. Since the signal may be cleaner (due, for example, to the pulse shielding by the grid), more accurate measurement of ion current is possible.

Using the above method, the relationship between H₂ pressure and exposure time for recharging the substrate may be determined. Therefore, a partial pressure of H₂ may be maintained in the system to continually reload the substrate between pulses of a pulsed ionization operating mode. A frequency for initiation of ionization may be calculated, while keeping the pressure low enough that the mean free path of H₂ is sufficiently large in comparison to the diode gap.

A system may be set up with a diode ionization source in a partial pressure of H₂ that is activated with a pulsed high voltage of correct frequency and pulse width to maximize the ionization current from the device.

There are several embodiments for making a neutron generator. In the configuration shown in FIG. 1, as previously noted, the CNT film is coated on the inside of the outer cylinder, and a counter electrode is co-axial inside the cylinder. A sufficient bias between the outer cylinder and the inside electrode (inside electrode negative bias with respect to the outer cylinder) may ionize hydrogen or deuterium atoms and accelerate them to the inner cylinder. Other gas atoms may also be used.

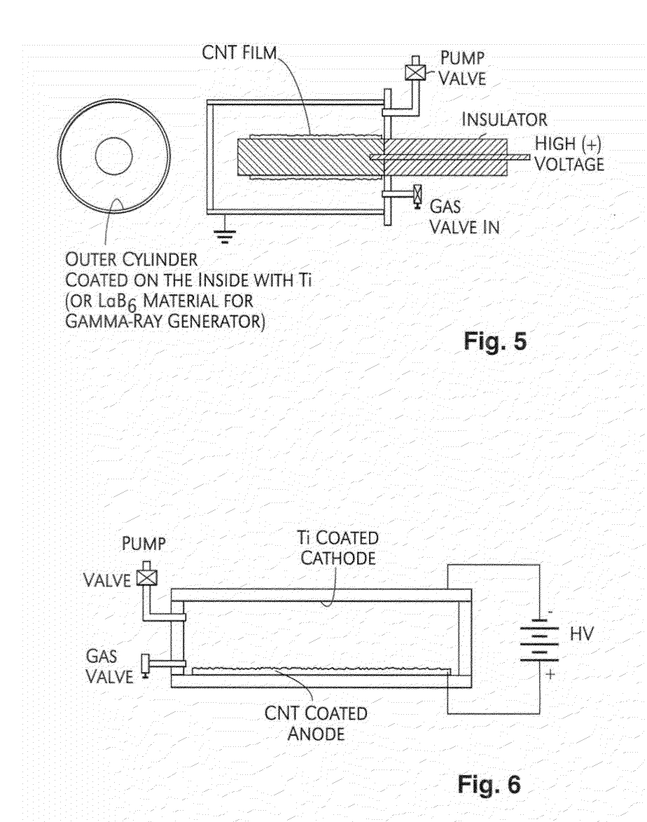

Another configuration is with the CNT coated on the outside of the inner cylinder, with ions accelerated to the outer cylinder. In this case, the potentials are reversed from FIG. 1. This configuration is shown in FIG. 5. For any bias used, the electric field strengths may be higher near the surface of the inner cylinder than near the surface of the outer cylinder (e.g., because of the smaller radius of the inner cylinder). Thus, for a given potential (e.g., 80 kV) needed to generate the neutron reaction as stated in Equation 1, the field strength needed to generate neutrons may be higher at the inner cylinder, allowing more ions to be generated per square area. The total area of CNT film is now less than in FIG. 1 by a ratio of r²/R² where r is the radius of the inner cylinder and R is the radius of the outer cylinder. On the other hand, the current density of the ion generation may be also non-linear with field strength, similar to current dependence for electron current for field emitters. If this is the case, it may be that the increase of electric field strength may overcome the loss of area and provide more ion current in the configuration of FIG. 1. Another advantage of this configuration is that the energy of the ion pulse may be spread over a larger area and local heating may be less.

The configuration shown in FIG. 3 may also be a suitable configuration for a neutron generator if the anode is coated with a field ionizer materials such as carbon nanotubes and the cathode is suitable target that is loaded with deuterium or tritium and the potential between the electrodes is on the order of 70 kV or higher. For a neutron generator, deuterium or tritium gas may be used in place of hydrogen. In some embodiments, the vessel may be loaded with D₂ or T₂ and then the gas source may be disconnected. The source may be reconnected later for recharging.

Another configuration is a flat anode and flat cathode, with the electrodes part of the vessel walls rather than separate parts inside as vessel, as shown in FIG. 3. This is a planar configuration shown in FIG. 6, which operates in a manner similar to the configurations illustrated in FIGS. 1 and 5.

The configuration shown in FIG. 4 may also be a suitable configuration for a neutron generator if the anode is coated with a field ionizer materials such as carbon nanotubes and the cathode is a suitable target that is loaded with deuterium or tritium and the potential between the electrodes is on the order of 70 kV or higher. For a neutron generator, deuterium or tritium gas may be used in place of hydrogen. In some embodiments, the vessel may be loaded with D₂ or T₂ and then the bottle can be disconnected. The bottle may be reconnected later for recharging. This embodiment is different from that shown in FIG. 3 in that in FIG. 4: an extra electrode is shown placed between the anode and cathode that may be used to modulate the ion current independently of the potential between the anode and cathode.

FIG. 4 may be modified such that the anode and cathode are part of the vessel walls and not independent electrodes inside a vessel. This may be similar to FIG. 6, with an extra electrode (control electrode) between the Ti-coated cathode and the CNT-coated anode. Another electrical circuit may be used to drive this control electrode.

Other configurations may have only one of the electrodes (either anode or cathode) as part of the vessel wall and the other electrode or electrodes inside the vessel walls. For electrodes inside the vessel walls, suitable electrical feedthroughs may connect the electrodes to the driving circuits.

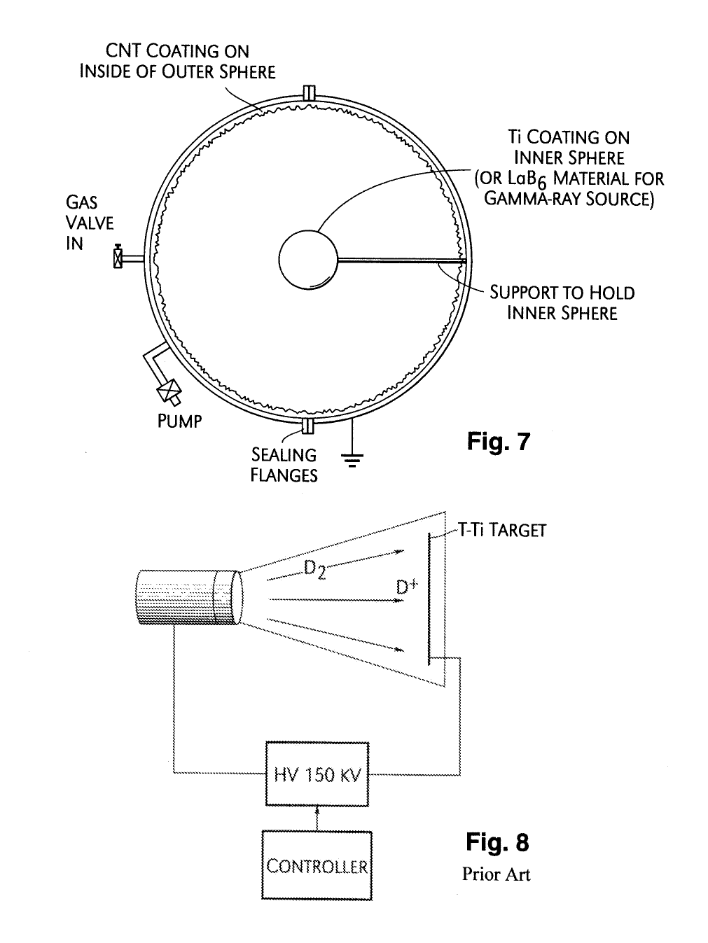

Another configuration is a spherical configuration as shown in FIG. 7. As in FIG. 1, the CNT film (or treated CNT film) is coated on the inside of the outer sphere. An inner sphere is centered with the outer sphere, supported by mechanical supports. A high voltage lead (not shown) biases this inner sphere relative to the outer sphere (inner sphere negative potential with respect to the outer sphere). At sufficient potential, hydrogen or deuterium gas ions may be generated at the CNT film and accelerated to the inner sphere. This configuration is similar to FIG. 1, except now it is spherical and not cylindrical. Additionally, the outer sphere may be two halves of a sphere that are sealed together at the sealing flanges. When the two halves are apart, the CNT film is coated on the inside of the outer sphere. Then the two halves may be brought together and sealed at the sealing flanges to form one outer sphere. The same may be true in FIG. 1: the outer cylinder may be two halves of a cylinder that are brought together to form one cylinder. Similarly, FIG. 5 may also be made into a spherical configuration.

In some embodiments, CNT material may be used as a source of ions whereby deuterium atoms are first adsorbed onto the CNT and then a strong electric field is applied to the CNT electrode by a counter electrode and a power supply such that an electron from the adsorbed atom (deuterium or tritium) tunnels into the conduction band of the CNT material and the remaining ion (deuterium or tritium, D or T) is accelerated to the counter electrode. This first mode of ionization is referred to herein as “desorption field ionization.” This works also for D or T gas molecules that are near the CNT field ionization source; the D or T may not have to be adsorbed onto the surface but may be ionized by being closer by. This second mode of ionization is referred to herein as “gas phase field ionization.”

The counter electrode described above may be a grid through which the ion may pass and be accelerated to another electrode (target electrode) that is coated or loaded with deuterium or tritium such as titanium-deuterium metal hydride compound. The counter electrode may also act as a target electrode (diode mode—only two electrodes). When D or T ions are accelerated to 70 kV or higher and strike other D or T atoms on the target electrode, neutrons may be produced.

Embodiments described herein are related to the generation of the ion current and to configurations that are used in the generation of ion current. Another method of generating D or T ions is through electron impact ionization. In this case, an electron beam is accelerated into a gas that contains D or T molecules. Through impact of the electron beam on the molecule, one or more electrons may be knocked off of the molecule to create D₂⁺ or D⁺ ions (similar for T molecules). Electron impact ionization is used commercially in electron ion sources available from, for example, Technishe Universitat Dresden, Institute for Applied Physics, DREEBIT GmbH (Dresden, Germany).

Described herein are configurations that make use of an electron beam from a cold cathode e-beam source such as a carbon nanotube e-beam source (CNT e-gun) for a neutron source.

In FIGS. 9-12, the vacuum vessels are omitted for clarity, but understood to be present. It is well known that neutron generators operate with a partial pressure of D₂ or T₂ gas and that proper metal and insulator vessels are needed to contain the gas at sub-atmospheric pressures and to electrically isolate the high potentials.

FIG. 9 shows a configuration in which electrons are extracted from a cold cathode (such as CNT cold cathode) by an extraction grid. The extraction grid may be either a suspended metal foil grid or metal layer on a microfabricated structure. A third electrode (target electrode) may be further down stream and biased at a negative high potential. After the field emitted electrons pass through the grid, the electrons may be decelerated by the target potential and forced back to the extraction grid. Along the path of the electron trajectory, it may strike a D or T molecule and ionize it. Atomic ions are preferred and are more likely if the electron beam current is high and there are many electrons present to ionize the molecules to create atomic ions. Magnetic fields may also be added. In some cases, the magnetic field lines are coaxial with the e-gun beam direction—shown by the arrow in FIG. 9.

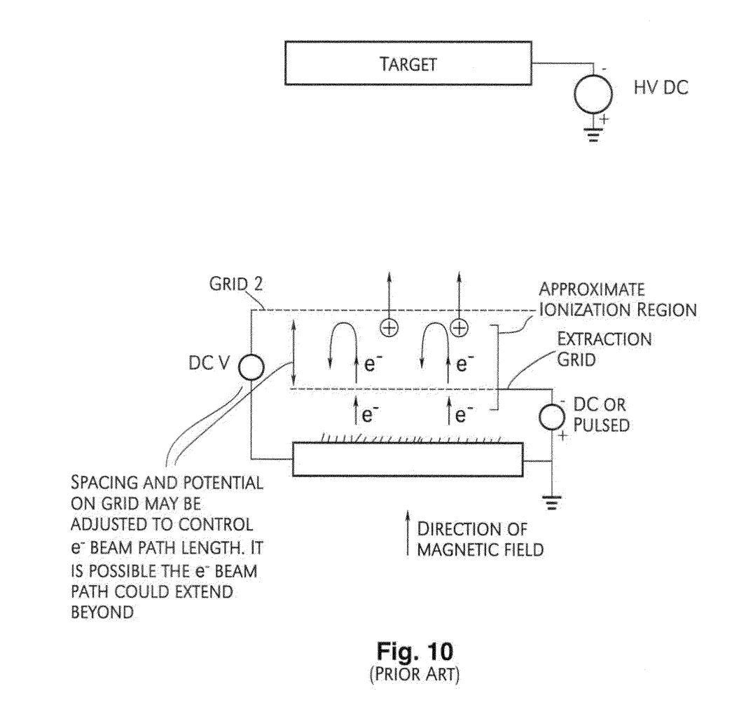

Another electrode may be added to adjust the distance that the electron beam travels by shielding the target potential from the electron beam. The longer the distance, the more likely the electron will strike a neutral D or T molecule and ionize it, and thus increase the ion current level. This second grid (called Grid 2) may also shield the target potential from the ions that are created. Thus, a balance between the gain of ions created by the longer beam path and the loss of ion current (e.g., ions are not pulled out of the ionization region) may be needed. An example is illustrated in FIG. 10. Grid 2 may be a collector electrode (e.g., an electrode with potential Vc as depicted in “Hydrogen ion production using carbon nanotube field emitter arrays,” Shaw et al., Vacuum Nanoelectronics Converence 2007 IVNC. IEEE 20^{th} International Volume, Issue 8-12, July 2007, pp. 6-7, which is hereby incorporated by reference herein), in which a target electrode is implied for a neutron generator, but not shown.

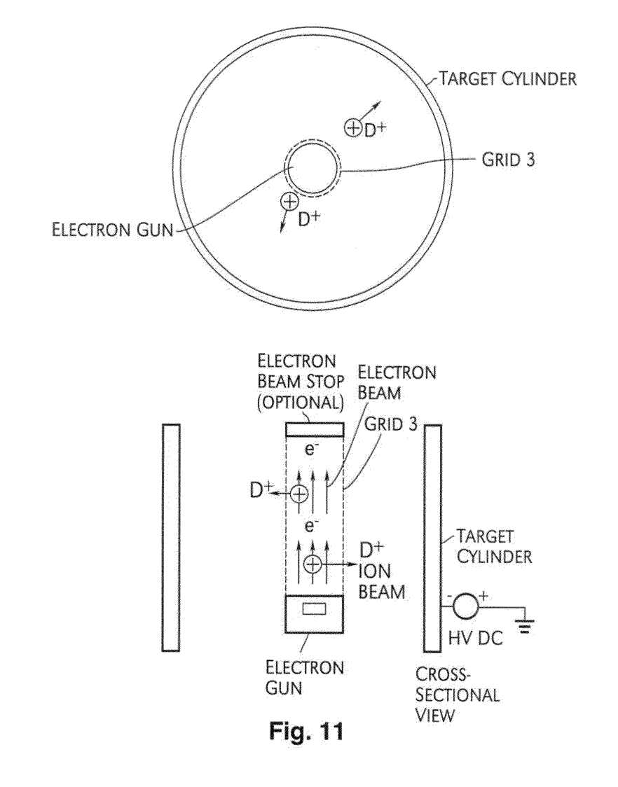

In another embodiment, a shield grid may be co-axial with the electron beam and allow the ions to be extracted perpendicularly to the electron beam. FIG. 11 illustrates this concept. Grid 3 (similar to Grid 2 in FIG. 10) is close to the beam and parallel to it. This configuration may have several advantages. For example, the electron beam may be very long, increasing the ion current. Additionally, the ion extraction may be very close to where the ions are created, making more use of the ions that are created, and leading to an increase in ion current. Furthermore, when the target is a cylinder and the ion beam is highly distributed on the inside surface of the target electrode, a higher total ion beam current may be allowed since the local beam current density is lower.

The electron beam in FIG. 11 may be generated by a CNT or other cold cathode material on a substrate and an extraction grid, similar to CNT-coated substrate+extraction grid configuration shown in FIG. 9. The potential on Grid 3 may be adjusted to increase (e.g., allow maximum) ion current to the target. In some cases, the potential on Grid 3 may be substantially the same as the potential on the extraction grid (e.g., to simplify construction of the ion source and decrease the number of power supplies needed).

In some embodiments, a beam stop may be used to stop the electron beam.

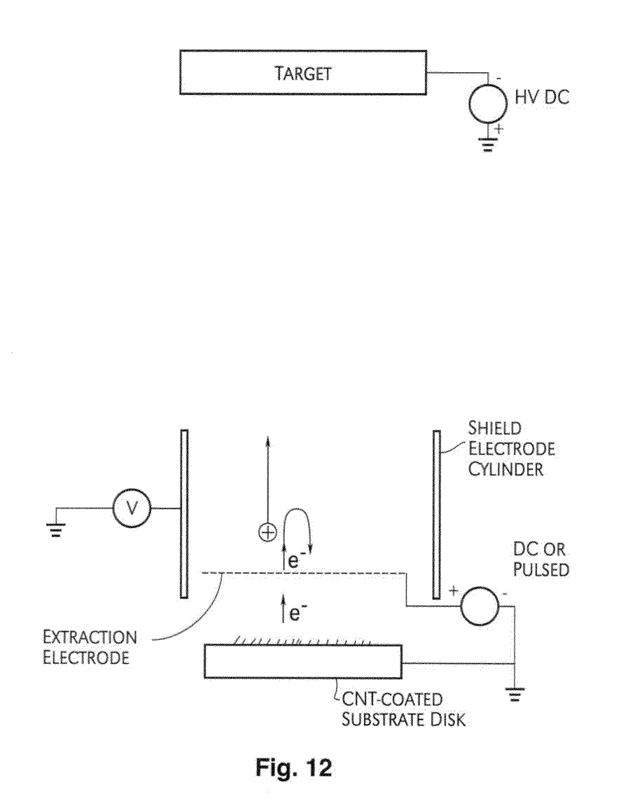

An alternative configuration includes the in-line configuration of FIG. 9 and FIG. 10, with a beam shield electrode to help shield the target potential from the electron beam to increase the beam path length (thus increase the ion current density). This alternative configuration is shown in FIG. 12. This shield electrode may be a grid or may be metal foil with no perforations or holes in the foil. The potential on this grid may be substantially the same as, or different than, the potential on the electron extraction grid. The height and/or diameter of the shield grid may be varied to improve (e.g., optimize) the ion current. In some cases, the diameter of the shield grid may be about the same as the height of the shield grid above the extraction grid (e.g., if the shield grid potential is about the same as the extraction grid potential). This configuration may allow a high percentage of ions that are created to pass to the target. An advantage of this configuration includes substantially equal potential lines inside the shield grid (ionization region), which may provide focusing or defocusing of the ion beam that is created. The capability of focusing or defocusing the ion beam may allow adjustment of the size of the target or the power density of the ion beam on the target.

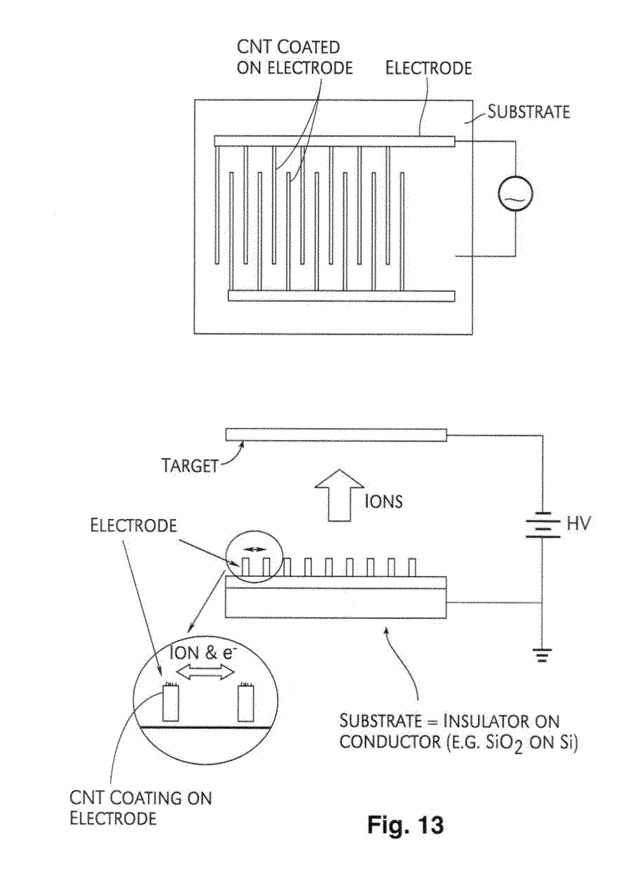

Yet another alternative configuration includes an interdigitated (comb-like) set of electrodes. Each electrode includes a multiplicity of fingers such that the fingers from one electrode are positioned between the fingers of the other electrode (see FIG. 13). The electrodes may be located on the surface of a substrate. The substrate may be insulating or it may have an insulating layer that is placed on a conducting or semiconducting substrate (e.g., a silicon oxide layer on a silicon substrate material). A silicon wafer may be doped to improve conductivity. Other examples are possible. The insulating layer may be positioned between the electrode layer and the conducting or semiconducting substrate. A layer of carbon nanotubes (CNT) may be placed on the surface of the electrodes (e.g., in the finger region of the electrodes).

By biasing one of the electrodes positive with respect to the other electrode or by placing an alternating voltage between the electrodes, electrons from one or both electrodes may be emitted to the other electrode. For alternating bias, both electrodes may emit electrons on alternating cycles of the bias. For both AC or DC bias, the bias may be sufficient to pull electrons from the electrodes. This is easier if the electrodes are coated with material that has a sharp, needle-like structure (e.g., carbon nanotubes). This bias may also be dependent on the gap between the electrodes and other physical parameters. An AC bias is preferred, but a DC bias may also be used.

The electrons emitted from the electrodes may impact molecules or atoms in the gas between the electrodes. This action may result in creation of ions (molecules or atoms with an electrical charge resulting from the removal or addition of one or more electrons). The higher the electron current between the electrode, the more ions that will be created. Also, if the gas pressure is higher, there may be more gas molecules to ionize and more ions may be created. If the gas pressure is too high or the electron current is too high, an are breakdown may occur or the electrodes may erode away too quickly. The operating parameters may be balanced to achieve high performance (high ion current) and long life and device stability. For a neutron generator, the gas species may be either D₂ or T, (deuterium or tritium), or a combination thereof. The pressure may range between 1 mTorr and 100 mTorr. The device operating parameters may be adjusted to achieve high ratio of D⁺ ions to D₂⁺ ions. In some cases, D⁺ ions are preferred. Once the ions are created, they are accelerated to the target electrode that is at a negative high potential (e.g., greater than 70 kV). Neutrons may be generated by the collision of the ions to other D or T atoms that are on the surface of the target. The HV target bias may be between the target and the electrode substrate (as shown in FIG. 13) or it may be between the target and the electrode on the ionizer substrate. The bias may be made such that ions created near the two comb-like electrodes are accelerated at high potential to the target surface.

Fabrication of a neutron generator may include fabrication of comb-like electrodes on a substrate, coating of a CNT layer on at least a portion of the electrodes, and activating the CNTs. The electrode structure may be placed into a vessel or container that can be evacuated. The container may be evacuated, and the circuit may be connected as illustrated in FIG. 13. Alternative circuits may also be used. After the container is filled with an appropriate gas, an alternating or pulsed voltage is applied on the CNT comb-like electrodes, and a negative high voltage is applied on the target to generate neutrons.

The configuration depicted in FIG. 13 offers several advantages. For example, since the spacing between electrode pairs illustrated in FIG. 13 can be very close, the driving voltage may be low (e.g., several tens of volts). Additionally, near the sample surface region, since the charge (ions and electrons) is induced by a low driving voltage, the charges are low-energy charges (“soft” charges), which may cause less impact damage to the CNTs, so that a longer life may be expected. Furthermore, the narrow spacing between electrode pairs may permit the device to be able to work at higher gas pressure conditions.

1. An apparatus comprising:
an enclosed chamber;
an electron beam source positioned relative to the enclosed chamber, the electron beam source coated with a carbon nanotube (CNT) film;
a shield grid in a form of a cylinder;
a target material in a form of a target cylinder outside of and coaxial with the shield grid, wherein the electron beam source is positioned and configured so that an electron beam emitted from the electron beam source is inside of and coaxial with walls of the shield grid and walls of the target cylinder; and
circuitry configured to apply a high voltage potential to the target cylinder.

2. The apparatus as recited in claim 1, wherein the target material comprises a material loaded with deuterium or tritium, wherein the high voltage potential is configured to cause ions created within the enclosed chamber to be pulled towards the target cylinder resulting in a reaction on a surface of the target material that generates neutrons.

3. The apparatus as recited in claim 1, wherein the target material comprises a material configured to generate neutrons in response to a reaction on a surface of the target material as a result of bombardment by ions created within the enclosed chamber.

4. The apparatus as recited in claim 3, further comprising deuterium molecules within the enclosed chamber.

5. The apparatus as recited in claim 1, wherein the target material comprises a material configured to generate gamma rays in response to a reaction on a surface of the target material as a result of bombardment by ions created within the enclosed chamber.

6. The apparatus as recited in claim 5, further comprising hydrogen atoms within the enclosed chamber, wherein the target material comprises LaB₆.

7. The apparatus as recited in claim 4, wherein the electron beam source is configured to produce the ions when the deuterium atoms within the enclosed chamber are bombarded by the electron beam.

8. The apparatus as recited in claim 7, wherein the electron beam source is physically configured relative to the shield grid and the target cylinder so that the ions that are produced are extracted and pulled towards the target material in a direction perpendicular to a path of the electron beam and the walls of the shield grid.

9. The apparatus as recited in claim 1, wherein the electron beam source is configured so that the electron beam is emitted by the CNT film when an electric field is applied to the CNT film.

10. The apparatus as recited in claim 3, further comprising tritium molecules within the enclosed chamber.

11.-21. (canceled)

22. The apparatus as recited in claim 8, further comprising circuitry for applying a potential to the shield grid so that it shields the ions from the high voltage potential of the target cylinder.
